(19) United States
(12) Patent Application Publication
(10) Pub. No.: US 2019/0113439 A1
(43) Pub. Date: Apr. 18, 2019

(54) Wireline Signal Noise Reduction

(71) Applicant: Halliburton Energy Services, Inc., Houston, TX (US)

(72) Inventors: Luis Emilio San Martin, Houston, TX (US); Thomas Louis Yonley, Houston, TX (US)

(73) Assignee: Halliburton Energy Services, Inc., Houston, TX (US)

(21) Appl. No.: 15/547,743

(22) PCT Filed: Aug. 12, 2016
(86) PCT No.: PCT/US2016/046826

§ 371 Date: Jul. 31, 2017

(51) Int. Cl. G01N 17/04; E21B 47/12; E21B 47/00; G01V 3/28

(52) U.S. Cl. CPC G01N 17/04; E21B 47/122; E21B 47/011; G01V 3/28; E21B 47/00

(57) ABSTRACT

A wireline system and method for removing wireline noise from an electromagnetic wireline tool comprising. The system may comprise a wireline measurement tool, which may comprise a wireline measurement tool body, a wireline cable traversing the tool body, and a wireline signal sensor measuring a signal induced by the wireline cable. The system may further comprise an electromagnetic wireline tool, comprising a wireline tool body, the wireline cable traversing the tool body, and a receiver measuring a signal. A method may comprise running the electromagnetic wireline tool into a wellbore on a wireline, recording wireline signals with a wireline signal sensor on a wireline measurement tool, recording signals with a receiver disposed on the electromagnetic wireline tool, and adjusting recorded signals on the receiver by subtracting filtered recorded signals from the wireline signal sensor.

### BACKGROUND

A common problem associated with subterranean wells may be the corrosion of conduits and other downhole equipment in the wellbore. The expense of repairing and replacing the damaged equipment may be high. Conduits that may be susceptible to corrosion may include casing, production tubing, and other downhole equipment. Examples of common types of corrosion that may occur in a wellbore include, but are not limited to, the rusting of metal, the dissolution of a metal in an acidic solution, and patina development on the surface of a metal.

Early detection of corrosion in conduits and other downhole equipment may be important to ensure the integrity and safety of the well. Techniques that have been deployed for downhole corrosion detection may involve running corrosion detection tools in the production tubing. Different types of corrosion detection tools may include mechanical calipers, ultrasonic acoustic tools, cameras, electromagnetic flux leakage, and electromagnetic induction tools. However, the ability of these tools to detect corrosion in outer casing beyond that which the logging tool is run may be limited. Electromagnetic induction tools that include at least one transmitting coil and at least one receiving coil may be able to detect corrosion in the outer casing. The transmitting coil may induce eddy currents inside the casings, including the inner and outer casing, and the receiving coil may record secondary fields generated from the casings. Those secondary fields bear information about the electrical properties and metal content of the casings and may be mathematically inverted to detect any corrosion loss in the metal content of the casings. Electromagnetic induction tools may be frequency domain tools that operate at discrete set of frequencies (e.g., higher frequencies to inspect inner casings) and lower frequencies to inspect outer conduits). Alternatively, the electromagnetic induction tools may operate in the time domain by transmitting transient pulses and measuring the decay response versus time (e.g., earlier time may correspond to inner casing and later time may correspond to outer casing).

Corrosion detection tools, either of time domain operation or frequency domain operation, may be disposed at the bottom of a wireline. Thus, corrosion detection tools may be designed to operate at the bottom of a wireline in a survey of a wellbore, which prevents power cables from moving through the corrosion detection device. In examples in which corrosion detection tools may be disposed at the top and/or center of the wireline, the corrosion detection tool may attach to a cable. The cable may comprise power lines that may be used to power other downhole devices disposed below the corrosion detection device on the wireline. The electricity moving through the power cables may produce a signal which may be recorded by the corrosion detection device. Detection of these signals may prevent, hide, and/or skew the recorded signals that may be produced from an electromagnetic field induced on an outer casing, which may prevent the identification of corrosion of conduits and other downhole equipment in a wellbore.

### BRIEF DESCRIPTION OF THE DRAWINGS

These drawings illustrate certain aspects of some examples of the present invention, and should not be used to limit or define the invention.

FIG. 1 is an example of a wireline tool disposed within a wellbore;

FIG. 2 is an example of a corrosion detection tool disposed on a wireline;

FIG. 3 is a flow chart that illustrates the method for determining a coefficient;

FIG. 4 is a schematic diagram of a method for subtracting out a coefficient from a recorded signal.

### DETAILED DESCRIPTION

Provided are an apparatus, system, and method that relate to the removal of induced signals generated in an electromagnetic wireline tool from readings recorded by the electromagnetic wireline tool. These induced signals may be referred to as “wireline noise” as these induced signals may include signals generated in receivers of the electromagnetic wireline tool caused by coupling that may occur from a running through the electromagnetic wireline tool. While the disclosed techniques may be particularly suitable for removal of induced signals recorded by corrosion detection tools, they may be applicable to any electromagnetic wireline tool where removal of the wireline noise may be desired. As used herein, the term “electromagnetic wireline tool” refers to a wireline tool that may be affected by an electromagnetic field.

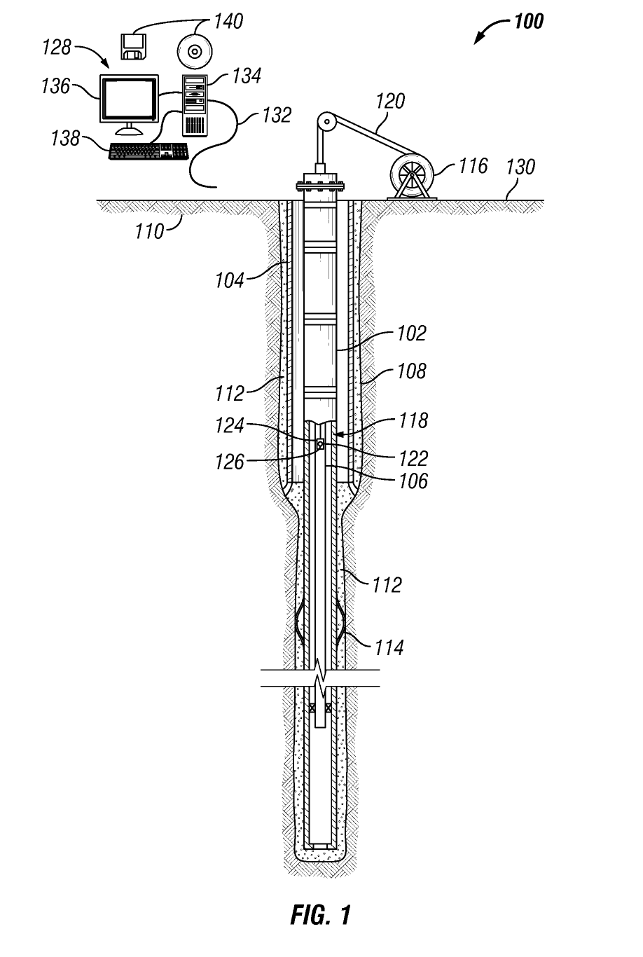

FIG. 1 illustrates an example wireline system 100 for use with a subterranean well. In the illustrated embodiment, wireline system 100 may be used to monitor one or more characteristics of conduits (e.g., first casing 102, second casing 104, inner tubing 106, etc.) over time. The conduits may comprise a suitable material, such as steel, chromium, or alloys. As illustrated, a wellbore 108 may extend through at least one subterranean formation 110. While the wellbore 108 is shown extending generally vertically into the subterranean formation 110, the principles described herein are also applicable to wellbores that extend at an angle through the subterranean formation 110, such as horizontal and slanted wellbores. For example, although FIG. 1 shows a vertical or low inclination angle well, high inclination angle or horizontal placement of the well and equipment is also possible. It should further be noted that while FIG. 1 generally depicts a land-based operation, those skilled in the art will readily recognize that the principles described herein are equally applicable to subsea operations that employ floating or sea-based platforms and rigs, without departing from the scope of the disclosure.

As illustrated on FIG. 1, one or more conduits, shown here as first casing 102, second casing 104, and inner tubing 106 may be disposed in the wellbore 108. First casing 102 may be in the form of an intermediate casing, a production casing, a liner, or other suitable conduit, as will be appreciated by those of ordinary skill in the art. Second casing 104 may be in the form of a surface casing, intermediate casing, or other suitable conduit, as will be appreciated by those of ordinary skill in the art. While not illustrated, additional conduits may also be installed in the wellbore 108 as desired for a particular application. In the illustrated embodiment, the first casing 102 and the second casing 104 may be cemented to the walls of the wellbore 108 by cement 112. Without limitation, one or more centralizers 114 may be attached to either the first casing 102 and/or the second casing 104, for example, to centralize the respective conduit in the wellbore 108, as well as protect additional equipment (e.g., electromagnetic field sensors, not illustrated).

In the illustrated embodiment, wireline system 100 may comprise a hoist 116 and an electromagnetic wireline tool 118. Without limitation, electromagnetic wireline tool 118 may comprise a corrosion detection tool. In examples, hoist 116 may be used to raise and/or lower electromagnetic wireline tool 118 in wellbore 108. Hoist 116 may attach to electromagnetic wireline tool 118 through wireline 120. Wireline 120 may be any suitable cable that may support electromagnetic wireline tool 118. Wireline 120 may also deliver power and/or transmit data to/from electromagnetic wireline tool 118 and/or one or more additional wireline tools that may be disposed on wireline 120. In examples, wireline 120 may be spooled within hoist 116.

Without limitation, a variety of different techniques may be used for operation of the electromagnetic wireline tool 118 for the generation of electromagnetic fields. For example, the electromagnetic wireline tool 118 may operate in the frequency domain and/or in the time domain. Electromagnetic wireline tool 118 may comprise a wireline tool body 122, a transmitter 124, and/or a receiver 126. Transmitter 124 and Receiver 126 may be coupled to or otherwise disposed on wireline tool body 122. Wireline tool body 122 may be any suitable material, including without limitation titanium, stainless steel, alloys, plastic, combinations thereof, and the like. While FIG. 1 illustrates a single transmitter 124 and single receiver 126 disposed within electromagnetic wireline tool 118, the present techniques may encompass the use of two or more transmitters 124 and receivers 126 on electromagnetic wireline tool 118.

Transmitter 124 may be operable to induce eddy currents in the one or more conduits. Transmitter 124 may include any suitable electromagnetic transmitter, including, without limitation, coil antenna, wire antenna, toroidal antenna and/or azimuthal button electrodes. While not illustrated on FIG. 1, a source may be used to energize transmitter 124. As will be appreciated by those of ordinary skill in the art, energizing the transmitter 124, for example, by application of current to the transmitter 124, should cause the transmitter 124 to generate an electromagnetic field, a primary field. In the illustrated embodiment, the electromagnetic field may induce eddy currents in the one or more casings (e.g., first casing 102, second casing 104, and inner tubing 106), resulting in secondary fields generated from the one or more conduits that may be detected and processed to determine characteristics of the conduits.

Receiver 126 may be operable to measure the primary fields and/or the secondary fields generated by the one or more conduits. Secondary fields contain information about the electromagnetic material properties of conduits (such as magnetic permeability, or conductivity) and geometry of conduits (such as inner and outer diameter, and thickness). In response to the secondary fields, receiver 126 may generate at least one signal that may be subsequently processed to determine at least one characteristic of the one or more conduits. Receiver 126 may include any suitable electromagnetic receiver, including, without limitation, receiver coils, magnetometers, wire antenna, toroidal antenna or azimuthal button electrodes.

Wireline system 100 may further comprise an information handling system 128. The information handling system 100 may be in signal communication with the electromagnetic wireline tool 100. Without limitation, signals from receiver 126 may be transmitted through wireline 120 to information handling system 128. As illustrated, information handling system 128 may be disposed at surface 130. In examples, information handling system 128 may be disposed downhole. Any suitable technique may be used for transmitting signals from wireline 120 to information handling system 128. As illustrated, a communication link 132 (which may be wired or wireless, for example) may be provided that may transmit data from wireline 120 to information handling system 128. Without limitation in this disclosure, information handling system 128 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, information handling system 128 may be a personal computer, a network storage device, or any other suitable device and may vary in size, shape, performance, functionality, and price. Information handling system 128 may include random access memory (RAM), one or more processing resources (e.g. a microprocessor) such as a central processing unit 134 (CPU) or hardware or software control logic, ROM, and/or other types of nonvolatile memory. Additional components of information handling system 128 may include one or more of a monitor 136, an input device 138 (e.g., keyboard, mouse, etc.) as well as computer media 140 (e.g., optical disks, magnetic disks) that may store code representative of the above-described methods. Information handling system 128 may also include one or more buses (not shown) operable to transmit communications between the various hardware components. Information handling system 128 may be adapted to receive signals from the electromagnetic wireline tool 118 that may be representative of receiver 126 measurements. Information handling system 128 may act as a data acquisition system and possibly a data processing system that analyzes receiver 126 measurements, for example, to derive one or more properties of the conduits.

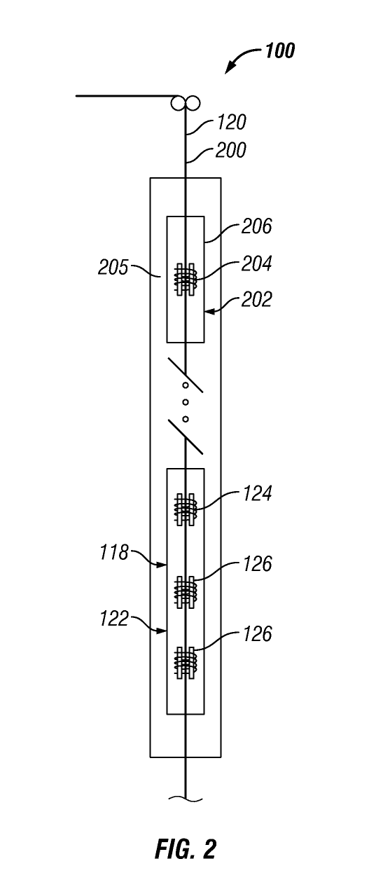

Referring now to FIG. 2, wireline system 100 is illustrated in more detail. As illustrated, electromagnetic wireline tool 118 is illustrated on wireline 120. As illustrated, wireline 120 may traverse through electromagnetic wireline tool 118 and connect to additional wireline tools and/or equipment on wireline 120. For example, wireline 120 may traverse through wireline tool body 122, transmitter 124, and receivers 126. While not illustrated, wireline 120 may comprise power lines that carry power to wirelines tools, such as electromagnetic wireline tool 118. The wireline 120 may also transmit communication signals to wireline tools. As the wireline 120 traverses through the electromagnetic wireline tool 118, these power and communication signals may interfere with the readings of electromagnetic wireline tool 118. Generally, the communication signals may be in a frequency range of larger than 100 kHz, while power signals may contain low frequencies, which may be as low as a few Hz. As the communication signals may be relatively large in comparison to the operating frequency of electromagnetic wireline tool 118, they may be unlikely to cause interference. However, the power lines may carry current with low frequency content, for example, less than 10 Hz, which may cause interference with operation of the electromagnetic wireline tool 118.

In examples, electromagnetic wireline tool 118 may generate an electromagnetic field through transmitter 124. The frequencies transmitted by transmitter 124 may contain very low frequencies, for example about 10 Hz or below, about 5 Hz or below, or about 1 Hz or below. These frequencies may allow the electromagnetic field to penetrate through inner tubing 106 and first casing 102 to induce an eddy current within second casing 104 (e.g., FIG. 1). In examples, the electromagnetic field may penetrate six metal conduits to reach the outer most conduit. The total metal thickness through which the electromagnetic field penetrates may be larger than two inches. Thus, the frequencies used to reach the outermost conduit may be very low, which may require receivers 126 that can record small magnetic signals produced by eddy currents within the outer most conduit. By way of example, the receivers 126 may require many thousands of turns to allow pick up these small magnetic signals. However, the receivers 126 may also undesirably pick up the signals moving through the wireline 120, which as previously disclosed, which may extend through electromagnetic wireline tool 118. Due to geometry constraints, wireline 120 may traverse through the electromagnetic wireline tool 118, and thus through receivers 126, to supply additional equipment on wireline 120 with power and/or a line of communication to information handling system 128. Referring to FIG. 2, electromagnetic wireline tool 118 may comprise a transmitter 124 and receivers 126. Wireline 120 may traverse through the center of transmitter 124 and receivers 126. Very low frequencies associated, for example, with power transmission in wireline 120, may produce signals that coincide with the spectrum of signals measured by receivers 126, which may prevent standard filtering techniques from filtering out signals produced by power line 200.

Previously, this interference with receivers 126 due to power transmission through wireline 120 may have limited placement of electromagnetic wireline tool 118 on wireline 120. For example, electromagnetic wireline tool 118 may need to have been the bottom most tool on wireline 120 so that power and other signals need not be transmitted through electromagnetic wireline tool 118. In a similar manner, this interference from wireline 120 may also limit placement of other electromagnetic wireline tools, wherein their recorded signals may also be undesirably impacted by wireline 120. However, it may be desirable in some instances to run power and other signals though electromagnetic wireline tool 118 or another wireline tool, for example, to reach wireline tools on a lower portion of wireline 120. A method of characterizing signals produced by wireline 120 that are then subtracted out of the recorded signals by receivers 126 in electromagnetic wireline tool 118 is disclosed below.

As illustrated in FIG. 2, wireline system 100 may further comprise a wireline measurement tool 202. Wireline measurement tool 202 may be attached to wireline 120. Wireline measurement tool 202 may be operable to measure signals generated by wireline 120 for which the recorded signals from receivers 126 may then be compensated. As illustrated, wireline measurement tool 202 may comprise a wireline signal sensor 204 and a wireline measurement tool body 205. Without limitation, wireline signal sensor 204 may be disposed on or otherwise coupled to wireline measurement tool body 205. In examples, wireline signal sensor 204 may be the same type of receiver (e.g. same type of coil) as receivers 126. In example, wireline signal sensor 204 may couple to wireline 120 in the same manner as receiver 126. Without limitation, wireline signal sensor 204 may be disposed at any location on wireline 120. In examples, wireline signal sensor 204 may be disposed about one foot, about five feet, about ten feet, and/or about fifteen feet from receiver 126. As illustrated, wireline signal sensor 204 may be disposed on wireline 120 at a distance of about five feet, about ten feet, about fifteen feet, or even longer from transmitter 124. While FIG. 2 shows wireline signal sensor 204 positioned above transmitter 124 and receivers 126, wireline signal sensor 204 may alternatively be positioned on wireline 120 below transmitter 124 and/or receivers 126. It should be noted that wireline signal sensor 204 may be disposed on wireline 120 at a distance from transmitter 124 that may be sufficient to prevent transmitter 124 signals from reaching wireline signal sensor 204. For example, a sufficient distance, without limitation, may be about five feet to about ten feet, about ten feet to about twenty feet, or about twenty feet to about forty feet. While FIG. 2 illustrates the electromagnetic wireline tool 118 and the wireline measurement tool 202 as separate wireline tools, the electromagnetic wireline tool 118 and the wireline measurement tool 202 may alternatively be configured as separate subassemblies of a common wireline tool, for example, with the wireline measurement tool body 205 and the wireline tool body 122 being a common tool body.

In examples, an electromagnetic shield 206 may be further used to isolate wireline signal sensor 204 from outside signals received from transmitter 124. As illustrated, electromagnetic shield 206 may form an enclosure in which wireline signal sensor 204 may be disposed. Electromagnetic shield 206 may comprise any suitable material for shielding wireline signal sensor 204 from electromagnetic fields external to electromagnetic shield 206, including without limitation, mu-metal, magnetic steel, which may be used in combination with copper, and/or any type of conductive material. Electromagnetic shield 206 may be used, for example, where wireline signal sensor 204 may be placed sufficiently close (e.g., within ten feet) of transmitter 124 so that transmitter 124 signals may not reach wireline signal sensor 204. Alternatively, electromagnetic shield 206 may be used in conjunction with spacing of wireline signal sensor 204 from transmitter to reduce coupling between transmitter 124 and wireline signal sensor 204. As illustrated, wireline 120 may traverse through the axis of electromagnetic shield 206, wireline signal sensor 204, and/or receivers 126. Shielded by electromagnetic shield 206 and coupled to wireline 120, wireline signal sensor 204 may only record signals induced by wireline 120 (i.e., wireline signals), which may include signals generated by power and/or communication signals in wireline 120. Recording the wireline signals of from wireline 120 may allow an operator to remove them from the multitude of signals recorded by receivers 126.

In operation, the wireline system 100 shown on FIG. 2 may be used for removing wireline noise from signals recorded by receivers 126. By way of example, the electromagnetic wireline tool 118 and wireline signal sensor 204 may be run into a wellbore 108 (e.g., shown on FIG. 1). The electromagnetic wireline tool 118 may be operated in the wellbore 108. Operation of the electromagnetic wireline tool 118 may include using transmitter 124 to generate an electromagnetic field. Electromagnetic field measurements may then be recorded by receivers 126. The signals recorded by receivers 126 may include, in addition to the primary field, measurements of secondary fields induced by one or more conduits as response to the excitation by the electromagnetic field from the transmitter 124. Because the wireline 120 may run through the electromagnetic wireline tool 118, the signals recorded by receivers 126 may include wireline noise, e.g., signals generated by power and/or communication signals in wireline 120. Wireline signal sensor 204 may also be operated in the wellbore 108. Operation of wireline signal sensor 204 may include using the wireline signal sensor 204 to measure electromagnetic field measurements. Measurements by the wireline signal sensor 204 may be referred to as the wireline signal. The wireline signal recorded by the wireline signal sensor 204 may include wireline noise, e.g., signals generated by power and/or communication signals in wireline 120. Because of spacing from transmitter 124 and/or use of electromagnetic shield 206, the wireline signal recorded by wireline signal sensor 204 may be primarily wireline noise. To remove the wireline noise from the signals recorded by the receivers 126, the signals recorded by the receivers 126 may be compensated for the wireline signal.

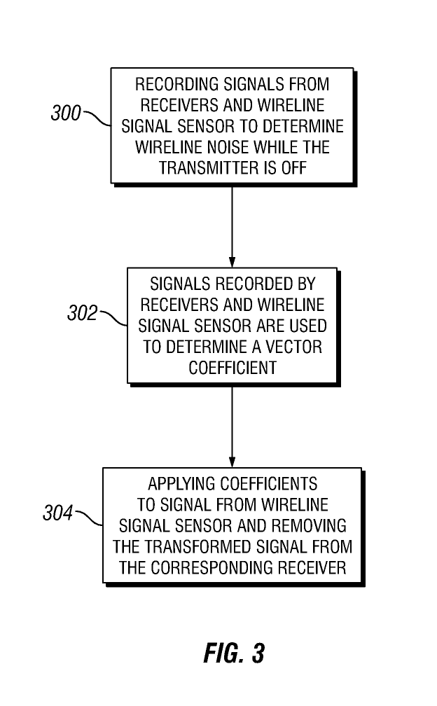

An example method of removing wireline noise from signals recorded by receivers 126 is illustrated in more detail in FIG. 3. In step 300, signals from receivers 126 and signals from wireline signal sensor 204 are recorded to determine the amount of wireline noise. Without limitation, the signals may be recorded under operation conditions while electromagnetic wireline tool 118 may be disposed within wellbore 108, in which measurements may be taken moments before logging operations begin. Measurements may also be performed with a completed electromagnetic wireline tool 118 in a lab setting. During testing, transmitter 124 should be off, which may allow receiver 126 to record only signals produced from wireline 120, wireline noise during normal operating conditions. Specifically, transmitter 124 may be off, not energizing the antenna, but the current that may feed transmitter 124 may be circulated through an impedance equivalent to the antenna impedance, which may be implemented with a switch that connect to the antenna and/or the load that simulates the antenna. Thus, the relation between the signals induced in wireline signal sensor 204 and signals induced in receiver 126 may be evaluated. In examples the signal recorded from wireline noise may be extracted from processed data. Without limitation, receiver 126 and wireline signal sensor 204 may measure the signal broadcasted by wireline 120. The recorded spectrum of signals may be similar, thus a process for determining filtered recorded signals may be performed. In examples, coefficients may be utilized to distinguish between recorded signals. These coefficients may comprise filter coefficients that may be applied to the spectrum of recorded signals at wireline signal sensor 204, which may convert the signals into a signal measured at one of the receivers 126 (where each receiver 126 may have a different set of filter coefficients). The evaluated coefficients capture the relation between the wireline signal measured at wireline signal sensor 204 and the wireline signal measured at receivers 126. The evaluated relation between the signals induced in wireline signal sensor 204 and signals induced in receiver 126 may be implemented when electromagnetic wireline tool 118 may be operating with transmitter 124 on, the evaluated relationship may be used to subtract the wireline signals form receiver 126 using the measurements of wireline signal sensor 204. In step 302, the signals recorded by wireline signal sensors 204 and receiver 126 may be used to determine coefficients. Coefficients may transform the signal recorded by wireline signal sensor 204. Without limitation, the coefficients may transform the signal measured at wireline signal sensor 204 into a signal which may have been recorded at each individual receiver 126 and comprise signals from wireline 120.

Determining coefficients in step 302, of the above described method, may comprise a ratio between frequency components of the signals recorded by a receiver 126 and signals recorded by wireline signal sensor 204, where one coefficient for each frequency may be included in the frequency spectrum of each signal. To determine the coefficient, a discrete Fourier Transform may be performed on all signals recorded by individual receivers 126, all tool sensors, and/or wireline signal sensor 204. Determining the coefficient for individual receivers 126 using a ratio between the frequency components of the signals of receivers 126 and wireline signal sensor 204, is shown in Equation 1, where the index i may indicate the frequency component of the signals in a discretized version of the signals and the coefficients may be considered as filter coefficients to be applied to the signal in wireline signal sensor 204 to recover the signal in receivers 126, with a different set of coefficients for each different receiver in the set of receivers 126.

Coefficient(i)=([Receiver126]spectrum(i))/([sensor204]spectrum(i)) (1)

The resulting coefficient is a vector and there may be a coefficient for each frequency of the discrete Fourier Transform. In examples, there may be different vector coefficients for different receivers 126.

The derivation of individual coefficients for each receiver 126 may be used to transform the recorded signal from receiver 126 into a signal that may replicate the signal from wireline 120, which may have been recorded by individual receivers 126. In step 304, during normal operation with transmitter 124 broadcasting, the coefficients may be applied to the signal recorded by receiver 126 and the transformed signal may be removed from the signals recorded by corresponding receivers 126.

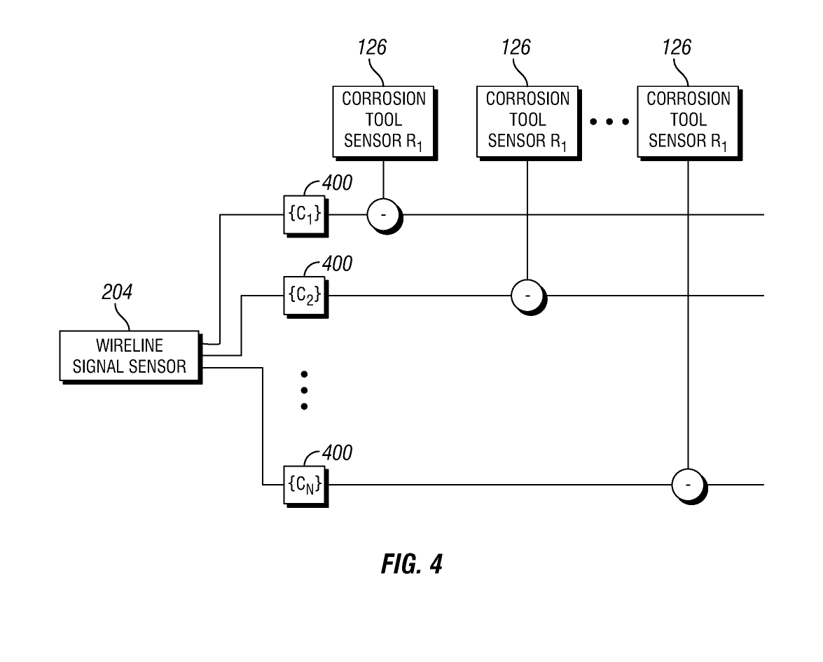

FIG. 4 illustrates the removal of signals, transformed from a set of derived coefficients, from signals recorded by receivers 126 through subtraction. The coefficients may be derived from the frequency spectrum of signals from receivers 126. Receivers 126 record signals moving though wireline 120 before operation of electromagnetic wireline tool 118. The signals recorded by receiver 126 and receivers 126 may be used to determine a first set of vector coefficient 400 for receiver 126, using Equation 1 above. As described above, each component of the vector coefficients may be derived from a different frequency used within Equation 1. The spectrum of signal recorded by receiver 126 may be transformed through multiplication by multiplying first set of vector coefficient 400 with the signal recorded by receiver 126. First set of vector coefficient 400 may transform the signal recorded by receiver 126 into a signal that may have been recorded by receiver 126, which may comprise signals from wireline 120. To remove the signals of wireline 120 from the recorded signals of receiver 126, the signal recorded by receiver 126, transformed by first set of vector coefficient 400, is subtracted from the signals recorded by receiver 126. This process may be repeated for each individual receiver 126. For example, a second set of vector coefficient, not illustrated, may be found for a second receiver, not illustrated, using Equation 1 above. After determining an individual coefficient for a second receiver 126, the signal transformed by second coefficient, not illustrated, may be used to subtract out the signals of wireline 120 from the second receiver 126. Without limitation, the subtraction method may be repeated for any number of sets of vector coefficients and/or receivers 126 that may be disposed on electromagnetic wireline tool 118. Removal of the wireline signal from recorded signals by receiver 126 may reveal a recorded signal free of signals emitted from wireline 120 at each individual receiver 126.

A wireline system which may comprise a wireline measurement tool. The wireline measurement tool may comprise a wireline measurement tool body, a wireline cable traversing the tool body, and a wireline signal sensor measuring a signal induced by the wireline cable. The wireline system may further comprise an electromagnetic wireline tool which may comprise a wireline tool body, the wireline cable traversing the tool body, and a receiver measuring a signal. This system may include any of the various features of the compositions, methods, and systems disclosed herein, including one or more of the following features in any combination. The wireline measurement tool and the electromagnetic wireline tool may be subassemblies of a wireline tool. The wireline signal sensor may be disposed around the wireline. The wireline signal sensor and the receiver may be the same type of device. The wireline signal sensor and the receiver may be coils. The wireline measurement tool may further comprise an electromagnetic shield forming an enclosure in which the wireline signal sensor may be enclosed, wherein the electromagnetic signal sensor may comprise at least one material selected from the group consisting of mu-metal, magnetic steel, copper, or conductive material. The electromagnetic wireline tool may further comprise a transmitter, wherein the wireline signal sensor may be spaced a distance of about ten feet from the transmitter. The wireline system may further comprise a transmitter coupled to the electromagnetic wireline tool. The transmitter may be a coil. The electromagnetic wireline tool may be a corrosion detection tool.

A wireline system may comprise a hoist, a wireline disposed from the hoist, an electromagnetic wireline tool coupled to the wireline. The electromagnetic wireline tool may comprise a tool body, a receiver coupled to the tool body, a wireline signal sensor coupled to the tool body, a magnetic shield, wherein the magnetic shield encloses the wirelines signal sensor, and an information handling system in signal communication with the electromagnetic wireline tool. This system may include any of the various features of the compositions, methods, and systems disclosed herein, including one or more of the following features in any combination. The wireline may traverses through the tool body. The wireline signal sensor may be disposed around the wireline. The receiver may be disposed around the wireline. The receiver and the wireline signal sensor may be the same type of device. The information handling system may be disposed on a surface of a wellbore and is connected to the corrosion detection tool through the wireline. The receiver may comprise a plurality or receiver coils. The electromagnetic wireline tool may be disposed in a wellbore, wherein the wellbore may comprise a plurality of casings.

A method for removing wireline noise from an electromagnetic wireline tool may comprise running the electromagnetic wireline tool into a wellbore on a wireline, recording wireline signals with a wireline signal sensor on a wireline measurement tool, recording signals with a receiver disposed on the electromagnetic wireline tool, adjusting recorded signals on the receiver by subtracting filtered recorded signals from the wireline signal sensor. This method may include any of the various features of the compositions, methods, and systems disclosed herein, including one ore more of the following features in any combination. The wireline signal sensor and receiver may be coupled to a tool body. The wireline traverses through a tool body and the wireline signal sensor may be coupled to the tool body. The filtered recorded signals are distinguished by a coefficient. The coefficient may be representative of the wireline signal sensor. Determining corrosion from the adjusted recorded signals.

The preceding description provides various embodiments of the systems and methods of use disclosed herein which may contain different method steps and alternative combinations of components. It should be understood that, although individual embodiments may be discussed herein, the present disclosure covers all combinations of the disclosed embodiments, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, and may be modified and practiced in different but equivalent manners apparent to those skilled in the art having the benefit of the teachings herein. Although individual embodiments are discussed, the disclosure covers all combinations of all of the embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of those embodiments. If there is any conflict in the usages of a word or term in this specification and one or more patent(s) or other documents that may be incorporated herein by reference, the definitions that are consistent with this specification should be adopted.

What is claimed is:

1. A wireline system comprising
a wireline measurement tool, comprising:
a wireline measurement tool body;
a wireline cable traversing the tool body; and
a wireline signal sensor measuring a signal induced by the wireline cable; and
an electromagnetic wireline tool, comprising
a wireline tool body;
the wireline cable traversing the tool body; and
a receiver measuring a signal.

2. The wireline system of claim 1, wherein the wireline measurement tool and the electromagnetic wireline tool are subassemblies of a wireline tool.

3. The wireline system of claim 2, wherein the wireline signal sensor is disposed around the wireline.

4. The wireline system of claim 1, wherein the wireline signal sensor and the receiver are the same type of device.

5. The wireline system of claim 1, wherein the wireline signal sensor and the receiver are coils.

6. The wireline system of claim 1, wherein the wireline measurement tool further comprises an electromagnetic shield forming an enclosure in which the wireline signal sensor is enclosed, wherein the electromagnetic signal sensor comprises at least one material selected from the group consisting of mu-metal, magnetic steel, copper, or conductive material.

7. The wireline system of claim 1, wherein the electromagnetic wireline tool further comprises a transmitter, wherein the wireline signal sensor is spaced a distance of about ten feet from the transmitter.

8. The wireline system of claim 1, wherein the wireline system further comprises a transmitter coupled to the electromagnetic wireline tool.

9. (canceled)

10. (canceled)

11. A wireline system comprising:
a hoist;
a wireline disposed from the hoist;
an electromagnetic wireline tool coupled to the wireline, wherein the electromagnetic wireline tool comprises:
a tool body;
a receiver coupled to the tool body;
a wireline signal sensor coupled to the tool body;
a magnetic shield, wherein the magnetic shield encloses the wirelines signal sensor; and
an information handling system in signal communication with the electromagnetic wireline tool.

12. The wireline system of claim 11, wherein the wireline traverses through the tool body.

13. The wireline system of claim 11, wherein the wireline signal sensor is disposed around the wireline.

14. The wireline system of claim 13, wherein the receiver is disposed around the wireline.

15. The wireline system of claim 11, wherein the receiver and the wireline signal sensor are the same type of device.

16. The wireline system of claim 11, wherein the information handling system is disposed on a surface of a wellbore and is connected to the corrosion detection tool through the wireline.

17. The wireline system of claim 11, wherein the receiver comprises a plurality or receiver coils.

18. The wireline system of claim 11, wherein the electromagnetic wireline tool is disposed in a wellbore, wherein the wellbore comprises a plurality of casings.

19. A method for removing wireline noise from an electromagnetic wireline tool comprising:
running the electromagnetic wireline tool into a wellbore on a wireline;
recording wireline signals with a wireline signal sensor on a wireline measurement tool;
recording signals with a receiver disposed on the electromagnetic wireline tool; and
adjusting recorded signals on the receiver by subtracting filtered recorded signals from the wireline signal sensor.

20. The method of claim 19, wherein the wireline signal sensor and receiver are coupled to a tool body.

21. The method of claim 19, wherein the wireline traverses through a tool body and the wireline signal sensor is coupled to the tool body.

22. The method of claim 19, wherein filtered recorded signals are distinguished by a coefficient.

23. (canceled)

24. (canceled)
